(19) United States
(12) Patent Application Publication
(10) Pub. No.: US 2010/0167248 A1
(43) Pub. Date: Jul. 1, 2010

(54) Tracking and training system for medical procedures

(75) Inventor: Donncha Ryan, Dublin (IE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Haptica Ltd.

(21) Appl. No.: 12/318,601

(22) Filed: Dec. 31, 2008

(51) Int. Cl. G09B 23/28; H04N 7/18

(52) U.S. Cl. 434/262; 348/143; 348/E07.085

(57) ABSTRACT

A medical procedure training simulator may include a training space. The simulator may also include at least one camera in the training space. The at least one camera may be operable to capture video images of an object in the training space as one or more tasks are performed by at least one user. The simulator may also include a computer operable to receive the video images. The computer may also be operable to generate position data for the object by processing the video images. The computer may also be operable to generate a simulation of a scene from an operating room based on at least one of the video images and the position data. The computer may also be operable to display the simulation to the at least one user on an electronic display as the one or more tasks are performed by the at least one user.

### TECHNICAL FIELD

The present disclosure relates to tracking users and training users, and more particularly, to tracking users while they perform medical procedures, and training users to perform medical procedures.

### BACKGROUND

Traditional surgical education is based on the apprentice model, where students learn within the hospital environment. Educating and training students on actual patients may pose certain risks. Using simulation systems to educate and train students, instead of actual patients, eliminates those risks. However, simulation systems often times fail to accurately re-create real world scenarios, and thus, their usefulness for training and educating students may be limited.

Advanced simulation systems have been designed for educating and training students, while also attempting to make the educational and training processes more realistic. For example, at least one system has been developed that uses a simulator to provide users with the sense that they are performing a surgical procedure on an actual patient. The system is described in U.S. Patent Application Publication No. 2005/0084833 A1 to Lacey et al. (“Lacey”). Lacey discloses a simulator that has a body form apparatus with a panel through which instruments are inserted. Cameras capture video images of internal movements of those instruments within the body form apparatus, and a computer processes the video images to provide various outputs. However, the cameras do not capture video images outside of the body form apparatus, and thus, occurrences outside of the body form apparatus are not taken into account.

The present invention is directed to overcoming one or more of the problems set forth above and/or other problems in the art.

### SUMMARY

According to one aspect of the present disclosure, a medical procedure training simulator is provided. The simulator may include a training space. The simulator may also include at least one camera in the training space. The at least one camera may be operable to capture video images of an object in the training space as one or more tasks are performed by at least one user. The simulator may also include a computer. The computer may be operable to receive the video images. The computer may also be operable to generate position data for the object by processing the video images. The computer may also be operable to generate a simulation of a scene from an operating room based on at least one of the video images and the position data. The computer may also be operable to display the simulation to the at least one user on an electronic display as the one or more tasks are performed by the at least one user.

According to another aspect of the present disclosure, a system for tracking operating room activity is provided. The system may include at least one camera configured to capture video images of one or more objects in the operating room as one or more users perform a medical procedure. The system may also include a computer configured to receive the video images. The computer may also be configured to generate position data for the one or more objects by processing the video images. The computer may also be configured to provide metrics indicative of the quality of performance of the one or more users based at least on the position data.

According to another aspect of the present disclosure, a method for tracking operating room activity is provided. The method may include capturing video images of at least one object in the operating room during performance of a medical procedure on a patient. The method may also include generating position data describing movements of the at least one object by processing the video images. The method may also include providing performance metrics based at least on the position data.

According to another aspect of the present disclosure, a system for medical procedure training is provided. The system may include a space, and at least one camera in the space. The at least one camera may be operable to capture video images of a plurality of people in the space while the plurality of people perform one or more tasks. The system may also include a computer operable to receive the video images. The computer may also be operable to generate position data for the plurality of people by processing the video images. The computer may also be operable to generate performance metrics for the plurality of people as the one or more tasks are performed based at least on the position data.

### BRIEF DESCRIPTION OF THE DRAWINGS

FIG. 1 is a perspective view of a training system, according to an exemplary embodiment of the disclosure.

FIG. 2 is a diagram illustrating directions for tracking a marking, according to an exemplary embodiment of the disclosure.

FIG. 3 is a simulated scene, according to an exemplary embodiment of the disclosure.

FIG. 4 is another simulated scene, according to an exemplary embodiment of the disclosure.

FIG. 5 is a top view of a table, according to an exemplary embodiment of the disclosure.

### DETAILED DESCRIPTION

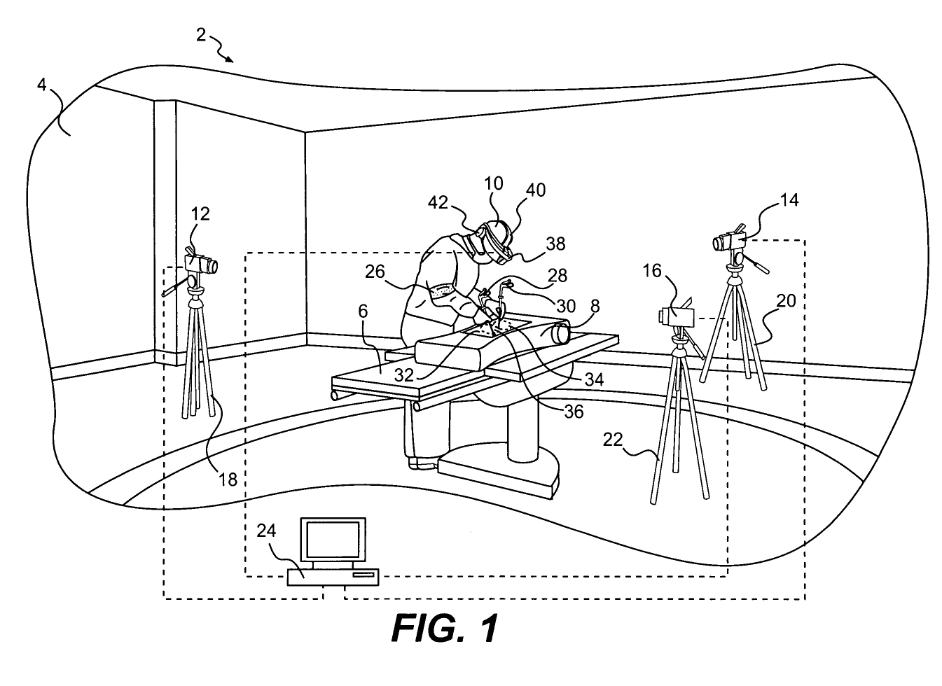

A system 2 for training users to perform procedures in an operating room environment may include a physical space 4, such as a room, an exemplary embodiment being shown in FIG. 1. Space 4 may include a table 6, such as an examination table, a surgical table, or a hospital bed; a body form apparatus 8; and/or any other suitable items for simulating a medical facility environment. FIG. 1 also shows a user 10 in space 4, standing next to table 6 and body form apparatus 8.

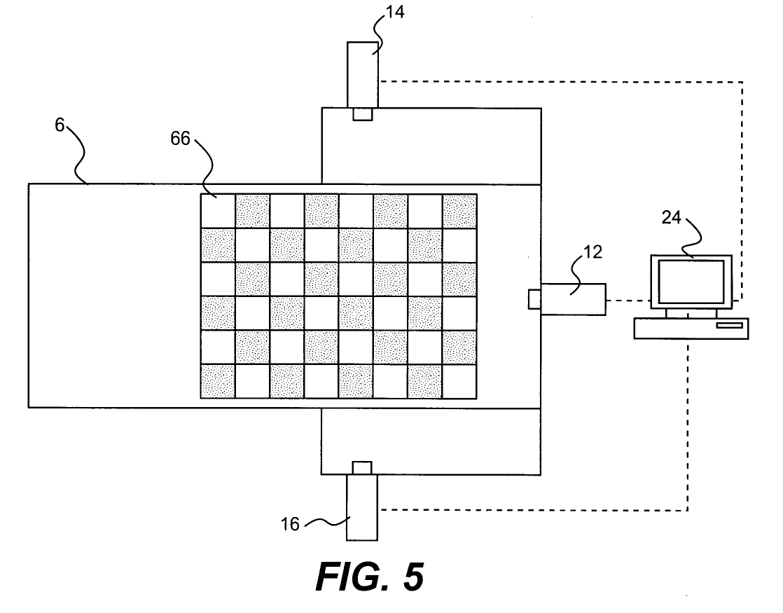

One or more cameras 12, 14, and 16 may be positioned in space 4 for capturing video images from a plurality of perspectives. The precise locations of cameras 12, 14, and 16 around a room may change depending on the shape or other characteristics of the room. Further, there may be only two cameras or greater than three in number. It is contemplated that cameras 12, 14, and 16 may be fixed in their respective locations. It is also contemplated that cameras 12, 14, and 16, may be mounted on table 6, as shown in FIG. 5. Alternatively, cameras 12, 14, and 16 may be mounted for movement. For example, cameras 12, 14, and 16 may be movably mounted on selectively adjustable bases 18, 20, and 22 and/or attached to walls of the ceiling of space 4.

If body form apparatus 8 is present in space 4, one or more cameras (not shown) may be placed within body form apparatus 8 to provide video images of scenes internally within body form apparatus 8. One such body form apparatus is described in U.S. Patent Application Publication No. 2005/0084833 A1 to Lacey et al., the entire disclosure of which is incorporated herein by reference.

Cameras 12, 14, and 16 may be connected to a computer 24. Computer 24 may selectively adjust (e.g., zoom, pan, and tilt) cameras 12, 14, and 16, allowing cameras 12, 14, and 16 to cover areas of space 4 from an even greater number of perspectives. Computer 24 may also be used to calibrate cameras 12, 14, and 16. A calibration pattern may be used in the calibration process. One embodiment of such a pattern, a black and white checkerboard pattern 66, is shown in FIG. 5. Checkerboard pattern 66 may be placed on a surface of table 6, a floor surface of space 4, or any other location visible to cameras 12, 14, and 16. Computer 24 may be programmed with the dimensions of table 6 and/or space 4, and thus, may be able to extract the positions of reference points on checkerboard pattern 66 in the three dimensional coordinate system of space 4. Cameras 12, 14, and 16 may capture video images of the same reference points in two dimensional coordinate systems. Computer 24 may correlate the positions of the reference points in the two dimensional coordinate systems to the positions of the reference points in the three dimensional coordinate system of space 4. Once the correlations between points in the video images and point in checkerboard pattern 66 have been established, computer 24 may execute one or more algorithms to solve for camera parameters. The camera parameters may include intrinsic parameters, such as focal length, principal point, and radial distortion coefficients. The camera parameters may also include extrinsic parameters, such as the position and orientation of a camera with respect to checkerboard pattern 66. Camera parameters may be determined for each of cameras 12, 14, and 16, and once this is accomplished, cameras 12, 14, and 16 will have been calibrated. Once cameras 12, 14, and 16 have been calibrated, computer 24 may be able to extract three dimensional position data for objects captured by cameras 12, 14, and 16, even if the objects cover checkerboard pattern 66. If cameras 12, 14, and 16 are moved, checkerboard pattern 66 may be uncovered, and the calibration process may be repeated to prepare cameras 12, 14, and 16.

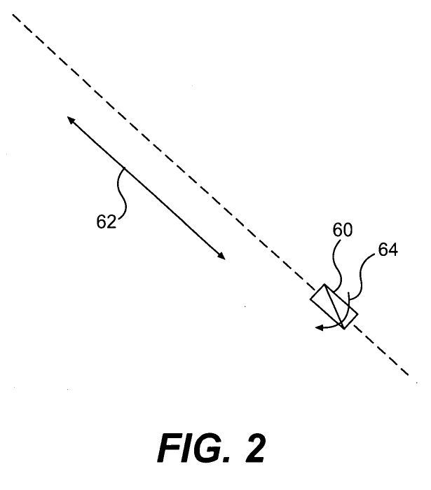

User 10 may wear a wearable article 26 when using system 2. Wearable article 26 may include a covering, such as an article of clothing, that may be worn on the user's head, body, or limbs. Wearable article 26 may also include an object or objects that may be attached to the user, or to the user's clothing, such as a strap. Wearable article 26 may include one or more markings. The markings may be similar to marking 60 shown in FIG. 2. The markings may be visible to cameras 12, 14, and 16. Computer 24 may monitor movements of the markings to track the location and movements of user 10 in space 4.

User 10 may hold and manipulate instruments 28 and 30 while using system 2. While instruments 28 and 30 are shown, it should be understood that additional or fewer instruments may be used with system 2 depending on the type of activities being performed by user 10. Instruments 28 and 30 may include markings, also similar to marking 60 of FIG. 2, that may be visible to cameras 12, 14, and 16, allowing computer 24 to monitor rotation, depth of insertion, or any other movements of instruments 28 and 30. Additionally, the markings may allow computer 24 to uniquely identify instruments 28 and 30. Instruments 28 and 30 may be designed to have the look and feel of real instruments used by medical personnel, or may be the real instruments, modified to include the markings. For example, the markings may be on stickers that are adhered to shaft portions of instruments 28 and 30.

Body form apparatus 8 may resemble at least a portion of the human body, for example the torso, and may be configured to provide tactile feedback to user 10. For example, body form apparatus 8 may include a sheet or membrane 32 that has the feel of human skin, and may also include objects 34 and 36, which may have the look and feel of organs, housed within body form apparatus 8. As user 10 brings instruments 28 and 30, or the user's own hands, into contact with the elements of body form apparatus 8, those elements may provide user 10 with tactile feedback, thus enhancing the realism associated with the exercises being performed by user 10. A motor, vibrating element, or some other actuator (not shown), may be attached to instruments 28 and 30 to further enhance the realism. It is also contemplated that body form objects 34 and 36 may include one or more markings, similar to marking 60 of FIG. 2. The presence of table 6 or any other equipment in space 4 may offer additional tactile feedback, further enhancing the realism of the environment.

Computer 24 may be configured to run one or more software programs, allowing computer 24 to use stereo triangulation techniques to track the location and movement in three dimensions of user 10 and any items (e.g., instruments 28 and 30, wearable article 26, body form objects 34 and 36, and/or medical equipment) in space 4. This process may be carried out using the markings. The process will be described here with respect to marking 60 (see FIG. 2), but it should be understood that the following description may also be applicable to any other markings. Marking 60 may include a tapered marking, a triangular grouping of infrared points, and/or any other suitable reference markings, that may provide computer 24 with reference points for use in determining the rotation of a body (not shown) on which marking 60 is affixed, the distance traveled by the body along axial direction 62 as indicated by arrow 64, and to uniquely identify the body from other bodies. The markings on wearable article 26, instruments 28 and 30, and objects 34 and 36, may be used in a manner similar to marking 60. Based on the location and/or movement of their markings, a motion analysis program, executed by computer 24, may generate three dimensional position data for user 10, instruments 28 and 30, wearable article 26, and objects 34 and 36, and may link the data with video images. The three dimensional position data and linked video images may form packets for use by other programs executed by computer 24.

Additionally or alternatively, cameras 12, 14, and 16 may feed live video images from space 4 into computer 24, and the motion analysis program may generate three dimensional position data based on the feed without requiring monitoring or tracking of the markings. For example, in one embodiment, the motion analysis program may initially receive and process video images of space 4 to produce a reference state. Afterwards, the motion analysis program may receive and process images of space 4 in another state. The reference state may correspond to an empty room, or an empty area in the room, while the other state may correspond to an occupied room, or an occupied area in the room. The differences between the empty room video images and the occupied room video images may be used to determine the regions of space 4 occupied by user 10 and/or items. Using such comparisons as starting points, the features and/or movements of user 10, instruments 28 and 30, wearable article 26, and/or objects 34 and 36, may be extracted.

Additionally or alternatively, wearable article 26, instruments 28 and 30, and/or objects 34 and 36, may include sensors (not shown) mounted thereon. The sensors may be operable to monitor the positions and movements of the bodies on which they are mounted. The movement and position data may be communicated to computer 24 by any conventional transmission arrangement.

For purposes of analysis, the video images and three dimensional data may be used as input data for a statistical analysis program executed by computer 24. The statistical analysis program may extract a number of measures from the data in real time as user 10 performs a task, including, for example, any suitable measures for describing and/or quantifying the movements of user 10 and instruments 28 and 30 during performance of the task.

A results processing program of computer 24 may use the measures extracted by the statistical analysis program to generate a set of metrics for scoring the user's performance on the physical exercise or task according to a series of criteria. The metrics may be generated in real-time as user 10 performs a task or after the task has been completed. Metrics may include, for example, the time required for user 10 to complete the task, the path lengths for movements performed by user 10, the smoothness of the user's movements, and/or the user's economy of movement. Metrics generated during performance of the task may be compared to a set of target metrics for the task. The target metrics may be obtained by using system 2 to monitor and track movements of a person skilled at performing the task (e.g., an instructor) while he or she performs the task. Additionally or alternatively, target metrics may be obtained using system 2 by monitoring and tracking movements of a surgeon as he or she performs the task during an actual medical procedure. The target metrics may also be obtained by analyzing gathered data and inputting the data directly into computer 24 without requiring monitoring and tracking using system 2. Comparing metrics generated during performance of the task by user 10 to the target metrics may provide a basis for scoring the user's performance. In addition, specific errors, such as instrument drift out of a predetermined boundary, may be flagged.

The video images from the motion analysis program may be displayed to user 10 on an electronic display 38, such as a computer screen or television set, in real time as user 10 performs a task. In one embodiment, electronic display 38 may be part of a virtual reality headset 40 worn by user 10. Virtual reality headset 40 may also include an audio device 42, including, for example, earphones, for transmitting audio streams. Additionally or alternatively, loudspeakers may by placed about space 4 to communicate an audio feed to user 10. The metrics from the results processing program may be displayed simultaneously with the video images on electronic display 38.

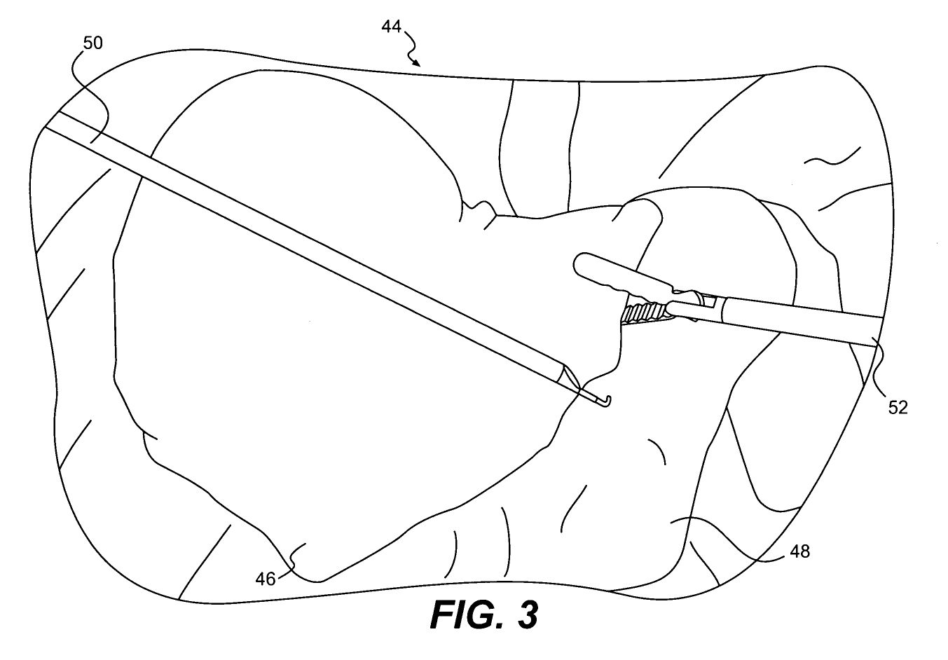

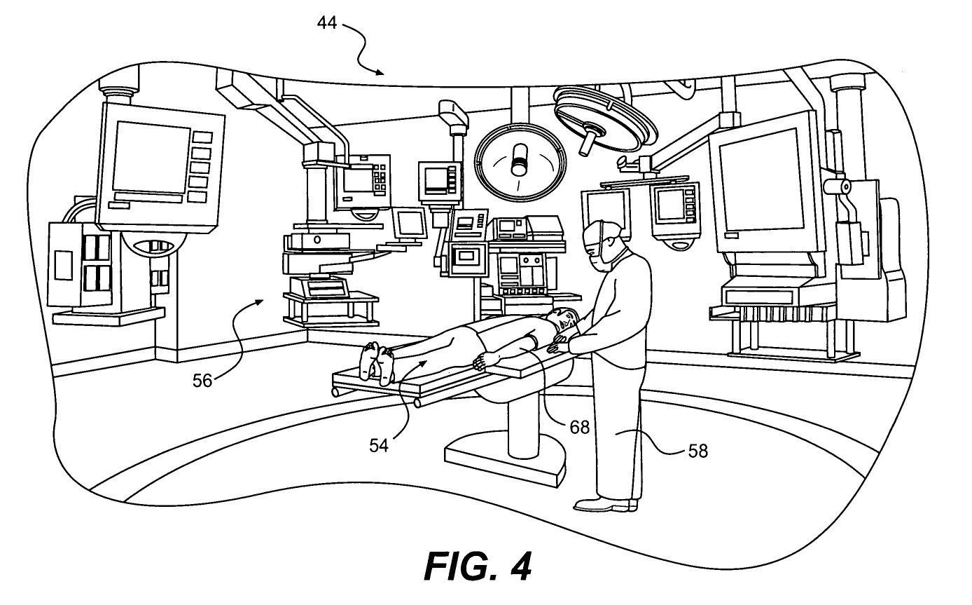

Computer 24 may also execute a graphics program that uses the three dimensional position data to generate a virtual reality simulation 44 in a coordinate reference space common to that of space 4. Examples of scenes from virtual reality simulation 44 are shown in FIGS. 3 and 4. The user may view virtual reality simulation 44 on electronic display 38 while user 10 performs a task to enhance the realism of the task. The graphics program may render views for display on electronic display 38 that have a viewing angle driven by the position and orientation of a first-person view of user 10. Accordingly, user 10 may be able to see different views of virtual reality simulation 44 as user 10 moves his or her head. For example, user 10 may see the view from FIG. 3 while standing near table 6 and looking downward, whereas user 10 may see the view from FIG. 4 when viewing table 6 from afar. At least one of the video images from the motion analysis program and the simulated video images from the graphics program may be fed into the statistical analysis program and the results processing program. The metrics produced may be displayed with simulated scenes on electronic display 38.

In this mode of operation, the user's view as he or she performs a task may not include live images of body form apparatus 8, but rather, may include anatomically correct simulations of human body parts, such as internal organs 46 and 48, as shown in FIG. 3. The graphics program may render internal organs 46 and 48 by generating virtual objects with space, shape, lighting, and texture attributes, for display on electronic display 38. Additionally, the graphics program may render simulated instrument models 50 and 52, and move them according to the current three dimensional data. For example, as long as instruments 28 and 30 are in space 4, their positions and orientations may be tracked. This three dimensional position data may be used to tell the graphics program where to render instrument models 50 and 52 within the simulation. A stream of three dimensional position data may keep instrument models 50 and 52 in step with the actual movements of instruments 28 and 30. Within the simulation, instrument models 50 and 52 may interact with the other elements of the simulation, with actions such as grasping, cutting, or suturing, thereby creating the illusion that instruments 28 and 30 are interacting with simulated internal organs 46 and 48. Models of other objects, including a user's hands, may also be generated, and may interact with elements of the simulation.

Internal organs 46 and 48 in a simulated scene may remain relatively static until the virtual objects are manipulated by user 10 as user 10 performs a task. The graphics program may move the surfaces of internal organs 46 and 48 if the three dimensional position of the user's hands, instruments 28 and 30, or wearable article 26, enters the space occupied by internal organs 46 and 48 as modeled. It is contemplated that one of instruments 28 and 30 may be a physical model of an endoscope, and may be handled by user 10. The position of its tip may be tracked in three dimensions by the motion analysis program. This may be treated as the position of a simulated endoscope, and its position and orientation may be used to drive the optical axis of the view in the simulation. Both end view and angled endoscope views may be generated. The graphics engine may render internal views of the simulated organs from this angle and optical axis. The view or views may be presented to user 10 on electronic display 38 as user 10 performs a task, and may simulate the actual view which would be seen if an actual endoscope were being used to perform the task, and it was inserted in a real body. This mode provides the ability to introduce graphical elements that may enhance the context around the task, or allow the introduction of random surgical events (such as a bleeding vessel, fogging of an endoscope, smoke from electrocautery, water from irrigation, and/or bleeding at an incision site) to be generated that require an appropriate response from user 10.

The user's view may also include anatomically correct simulations of other body parts, including, for example, external features 68 of body parts, as shown in FIG. 4. External features 68 may include elements of a head, torso, and/or limb, generally visible from outside the human body. The graphics program may render external features 68 by generating virtual objects, similar to those generated for internal organs 46 and 48. Instrument models 50 and 52, or models of a user's hands or other body parts, may also be generated, and may interact with external features 68 in the simulation. Thus, system 2 may be used to simulate the performance of procedures external to the human body or on its surface (e.g., non-invasive medical procedures, such as external suturing, physical examination and inspection, pulse-taking, auscultation of heart sounds and lung sounds using a stethoscope, temperature examination using a thermometers, respiratory examination, peripheral vascular examination, oral examination, abdominal examination, external percussion and palpation, blood pressure measurement using a sphygmomanometer, and/or ear and eye examination), as well as medical procedures performed internally within the human body (e.g., invasive medical procedures, such as internal suturing, laparoscopic Nissen fundoplication, ectopic pregnancy, anastomosis, laparoscopic cholecystectomy, and/or prostatectomy). In addition, while objects 34 and 36 may provide tactile feedback for users performing procedures within the body cavity, the outer surfaces of body form apparatus 8 may include materials that may provide tactile feedback for users performing procedures external to the body cavity.

Additionally or alternatively, computer 24 may execute a blending program for compositing video images for display side-by-side on electronic display 38, or by overlaying one on top of the other according to overlay parameter values. For example, the blending program may blend video images from the motion analysis program with recorded video images in real time as user 10 performs a task. The recorded video images may be part of a recorded video training stream of a teacher performing the same task. The training stream may be displayed with the real time video images from the motion analysis program. At the same time, the real time three dimensional position data from the motion analysis program may be sent to the statistical analysis program and the results processing program, along with three dimensional position data from the training stream, and metrics may be generated based thereon and displayed on electronic display 38. Thus, in this mode, the student's performance can be compared directly with that of the teacher. The results of this comparison can be displayed to user 10 on electronic display 38 visually as an output of the blending program, or as a numerical result produced by the results processing program, during and/or after performance of the task.

This mode may allow a teacher to demonstrate a technique within the same physical space as experienced by the student. The blending of the images may provide the student with a reference image that may help the student identify physical moves used in a procedure. Also, the educational goals at a given point in the lesson may drive dynamic changes in the degree of blending. For example, during a demonstration phase, the teacher stream may be set at 90%, and the student stream may be set at 10%. During a guided practice the teacher stream may be set at 50%, and the student stream may be set at 50%. During later stages of the training, such as during independent practice, the teacher stream may be set at 0%, and the student stream may be set at 100%. It is also contemplated that the speed of the recorded teacher stream may be controlled so it corresponds to the speed of the student. This may be achieved by maintaining a correspondence between three dimensional position data of the teacher and three dimensional position data of the student.

The display of the synchronized image streams can be blended as described above, or blended as image streams displayed side by side. The running of the respective image streams may take place as user 10 is performing a task, and can be: interleaved (student and teacher taking turns); synchronous (student and teacher doing things at the same time); delayed (the student or teacher stream being delayed with respect to other by a target amount); or event-driven (the streams are interleaved, synchronized, or delayed, based on specific events within the image stream or lesson script).

Additionally or alternatively, the blending program may blend real video images from the motion analysis program with video images from the graphics program, to provide a composite video stream of real and simulated elements for display to user 10 on electronic display 38 in real time as user 10 performs a task. In one embodiment, the three dimensional data from the motion analysis program may be fed to the graphics program, which may in turn feed simulated elements to the blending program. The simulated elements may be blended with the video images from the motion analysis program to produce a composite video stream made up of both real and simulated elements. This composite may be displayed on electronic display 38 for viewing by user 10. This mode provides the ability to introduce graphical elements that may enhance the context around a real physical exercise, or allow the introduction of random surgical events (such as a bleeding vessel, fogging of an endoscope, smoke from electrocautery, water from irrigation, bleeding at an incision site, and/or movement of medical equipment or personnel within space 4) to be generated that require an appropriate response from user 10. Additionally, the real, simulated, and/or blended video images may be linked to objects 34 and 36, thus combining tactile feedback from contact with objects 34 and 36 with visuals from the video images, to further enhance realism.

Computer 24 may also synchronize the act of blending with the act of generating metrics for simultaneous display of metrics and blended images as user 10 performs a task. For example, the three dimensional position data from the motion analysis program, and/or data from the graphics program, may be sent to the statistical analysis program and results processing program, where the metrics may be generated. The metrics may then be displayed on electronic display 38.

The graphics program may also render table 6, a patient 54, medical equipment 56, a virtual person 58, and/or any other suitable virtual objects, with space, shape, lighting, and texture attributes, for display on electronic display 38. These virtual objects may have similar attributes as the virtual objects described above, and as such, may be used and may behave in a similar manner.

An exemplary embodiment of computer 24, and a general description of some of its modes of operation, are provided in U.S. Patent Application Publication No. 2005/0084833 A1 to Lacey et al., the entire disclosure of which is incorporated herein by reference.

While a single user 10 is shown in FIG. 1, it should be understood that multiple users may use system 2 simultaneously. For example, one or more other users (not shown) may be in space 4 with user 10. Cameras 12, 14, and 16 may capture video images of the other users, in the same way as they capture video images of user 10. The other users, like user 10, may wear wearable articles, hold instruments, and receive tactile feedback from body form apparatus 8, objects 34 and 36, and/or any other objects in space 4, while using system 2. User 10 and the other users may be a team, and the team members may include physicians, nurses, observers, and/or any other personnel. Computer 24 may use the same stereo triangulation techniques described above with respect to user 10 to track the locations and movements in three dimensions of the other users, any instruments in space 4, the wearable articles of the other users, and/or objects in space 4.

Video images of each of the other users may be processed by computer 24, using the motion analysis program, statistical analysis program, results processing program, graphics program, and blending program, in the same way that video images of user 10 are processed by computer 24. Accordingly, just as for user 10, metrics for the other users may be generated. In a team environment, each team member may be asked to perform a different task, or a different part of a group objective, and so metrics for each user may be compared to expected metrics based on each user's specific task. Additionally or alternatively, metrics for the entire team may be generated by combining the metrics generated for each team member, and the team metrics may be compared to target team metrics. The target metrics may be obtained by using system 2 to monitor and track movements of a skilled team performing the same task or tasks (e.g., a team of instructors) while they perform the task or tasks. Additionally or alternatively, target metrics may be obtained using system 2 by monitoring and tracking movements of a team of medical personnel as they perform the task or tasks during an actual medical procedure. The target metrics may also be obtained by analyzing gathered data and inputting the data directly into computer 24 without requiring monitoring and tracking using system 2.

The other users may also wear virtual reality headsets, like headset 40 worn by user 10, while in space 4. Just as for user 10, the graphics program may generate scenes from virtual reality simulation 44 in each of the other users' headset devices, in accordance with each of the other users' positions in space 4 and their respective perspectives. Moreover, each user may appear as a virtual person in the other users' headset devices to increase the realism of the simulated environment. Furthermore, virtual objects in the simulated environment may be manipulated by the other users, as they are manipulated by user 10. The manipulation of virtual objects in the simulated environment by one user may be displayed in real time to another user, albeit from the other user's perspective.

System 2 may also be used to monitor a real operating room during performance of a medical procedure on a patient. The simulated environment shown in FIG. 4 may provide an indication of how a real operating room may look. In this mode of operation, computer 24 may operate in a manner similar to that described above, but without using the graphics program or blending program, since outputs from those programs would be unnecessary in a real operating room. Computer 24 may still receive video images from cameras 12, 14, and 16, and may still use stereo triangulation techniques to track the location and movement in three dimensions of one or more individuals and items in the operating room. Those items may include, for example, instruments being used during performance of the medical procedure, and/or wearable articles (either with or without markings) worn by the individuals. Based on the location and/or movement of those individuals and items, and/or markings associated with them, the motion analysis program may generate three dimensional position data for the individuals and the items.

The three dimensional data may be used as input data for the statistical analysis program, which may extract a number of measures from the data. The extracted data may then be used by the results processing program of computer 24 to generate a set of metrics for scoring the performance of the individuals according to a series of criteria. Metrics may include, for example, the time required for the individuals to complete their tasks, the path lengths for movements performed by the individuals, the smoothness of the movements performed by the individuals, and/or the economy of the individuals' movements. The metrics generated may be compared to a set of expected metrics for the same medical procedure. This comparison provides a basis for scoring the individuals' performances.

### Industrial Applicability

The disclosed system 2 may have applicability in a number of ways. System 2 may have particular applicability in helping users to develop and improve the skills useful in the performance of medical procedures. For example, users may use system 2 to learn the steps they should take when performing a medical procedure by performing those steps one or more times using system 2. Users may also use system 2 to sharpen their motor skills by performing physical exercises that may be required in an actual medical procedure, including medical procedures performed internally within the human body, as well as those performed external to the human body. For example, system 2 may be used to simulate steps taken in a human body cavity when performing laparoscopic surgery, and steps taken prior to entry in the human body, including, for example, preparation of an incision site, insertion of a trocar device or wound retractor, making of an incision, or any other suitable steps. System 2 may expose users to random surgical events associated with those steps, so that users may become familiar with actions they need to take in response to those events, in case those surgical events occur during an actual procedure. Moreover, the use of simulated environments may help make users more comfortable and familiar with being in an operating room environment.

System 2 may also score users using performance metrics. Scoring allows users to assess their level of surgical skill, providing a way for them to determine if they are qualified to perform an actual surgical procedure. Users may also compare scores after performing exercises to gauge their skill level relative to other users, and to determine the degree to which their skills are improving through practice. When system 2 is used in an actual operating room, scoring may provide users with a way to gauge their performance, and identify areas that need improvement.

System 2 may also be helpful for purposes of record-keeping. By monitoring the actions of users, system 2 may provide a record of events that occurred in training. Similarly, system 2 may also provide a record of events that occurred during the performance of an actual medical procedure. The record of events may be accessed after the training activity or medical procedure for analysis. Such records may be useful for identifying a user's strengths and weaknesses. Any weaknesses identified may be addressed by additional training. Furthermore, a person performing analysis of the record of events may be able to manipulate the video images by, for example, rewinding, fast forwarding, or playing them in slow motion, to assist with their review.

System 2 may also be useful for purposes of research and development. For example, system 2 may be used to test the feasibility of new instruments by comparing scores earned by users using known instruments, and comparing them with scores earned by users using new or experimental instruments. The same type of comparison may be used to determine if there are any benefits and/or disadvantages associated with changing an aspect of a medical procedure, such as, modifying a step in the procedure, using different equipment, using different personnel, altering the layout or environment of an operating room, or changing an aspect of the training process.

System 2 may also be helpful for marketing purposes. For example, system 2 may provide potential customers with the opportunity to test out new instruments by performing a medical procedure using the new instruments. System 2 may also provide potential customers with the opportunity to compare their performance while using one instrument, against their performance using another instrument, and identify the benefits/disadvantages associated with each instrument. Additionally, because system 2 provides users with haptic feedback during the performance of physical exercises, potential customers using system 2 may gain a “feel” for a new instrument by using it to perform a simulated medical procedure.

It will be apparent to those skilled in the art that various modifications and variations can be made in the disclosed system and methods without departing from the scope of the disclosure. Additionally, other embodiments of the disclosed system and methods will be apparent to those skilled in the art from consideration of the specification. It is intended that the specification and examples be considered as exemplary only, with a true scope of the disclosure being indicated by the following claims and their equivalents.

What is claimed is:

1. A medical procedure training simulator, comprising:
a training space;
at least one camera in the training space, the at least one camera being operable to capture video images of an object in the training space as one or more tasks are performed by at least one user; and
a computer operable to
receive the video images,
generate position data for the object by processing the video images,
generate a simulation of a scene from an operating room based on at least one of the video images and the position data, and
display the simulation to the at least one user on an electronic display as the one or more tasks are performed by the at least one user.

2. The medical procedure training simulator of claim 1, wherein the at least one camera is operable to capture video images of multiple users performing the one or more tasks in the training space, and the computer is operable to receive the video images of the multiple users, generate position data for the multiple users by processing the video images of the multiple users, and generate metrics for scoring the multiple users as the one or more tasks are performed.

3. The medical procedure training simulator of claim 1, wherein the training space includes a body form apparatus resembling a part of the human body.

4. The medical procedure training simulator of claim 1, wherein the at least one camera includes a plurality of cameras operable to capture video images of the object from multiple perspectives.

5. The medical procedure training simulator of claim 1, wherein the object is a surgical instrument.

6. The medical procedure training simulator of claim 1, wherein the object is an article worn by the at least one user.

7. The medical procedure training simulator of claim 1, wherein the object includes a marking visible to the at least one camera, the marking providing a reference point for measuring movement of the object.

8. The medical procedure training simulator of claim 1, wherein the object is a body part of the at least one user.

9. The medical procedure training simulator of claim 1, wherein the scene includes a simulated anatomically correct body part.

10. The medical procedure training simulator of claim 1, wherein the electronic display includes a screen in a virtual reality headset device worn by the at least one user.

11. A system for tracking operating room activity, comprising:
at least one camera configured to capture video images of one or more objects in the operating room as one or more users perform a medical procedure; and
a computer configured to
receive the video images,
generate position data for the one or more objects by processing the video images, and
provide metrics indicative of the quality of performance of the one or more users based at least on the position data.

12. The system of claim 11, wherein the one or more objects include a surgical instrument.

13. The system of claim 11, wherein the one or more objects include an article worn by the one or more users.

14. The system of claim 11, wherein the one or more objects include one or more body parts of the one or more users.

15. The system of claim 11, wherein the one or more objects include a marking visible to the at least one camera, the marking being configured to provide a reference point for measuring movement of the one or more objects.

16. A method for tracking operating room activity, comprising:
capturing video images of at least one object in the operating room during performance of a medical procedure on a patient;
generating position data describing movements of the at least one object by processing the video images; and
providing performance metrics based at least on the position data.

17. The method of claim 16, wherein generating position data includes using stereo triangulation to identify a position of the at least one object in three dimensions.

18. The method of claim 16, wherein providing performance metrics includes determining a path length of a movement of the at least one object.

19. The method of claim 16, wherein providing performance metrics includes gauging smoothness of a movement of the at least one object.

20. A system for medical procedure training, comprising:
a space;
at least one camera in the space, the at least one camera being operable to capture video images of a plurality of people in the space while the plurality of people perform one or more tasks; and
a computer operable to
receive the video images,
generate position data for the plurality of people by processing the video images,
generate performance metrics for the plurality of people as the one or more tasks are performed based at least on the position data.

21. The system of claim 20, wherein the computer is operable to compare the performance metrics to target metrics to obtain a score for the plurality of people.

22. The system of claim 20, wherein the space is one of an operating room and a training room.
